(19) United States
(12) Patent Application Publication
(10) Pub. No.: US 2021/0232449 A1
(43) Pub. Date: Jul. 29, 2021

(54) ASYNCHRONOUS DIGITAL PROTOCOL GENERATOR FOR ONE-WAY COMMUNICATION STREAMS

(71) Applicant: Curbell Medical Products, Inc., Orchard Park, NY (US)

(72) Inventor: Edward Wilkolaski, South Wales, NY (US)

(21) Appl. No.: 16/774,106

(22) Filed: Jan. 28, 2020

(51) Int. Cl. G06F 9/54; G06F 13/20; G06F 11/10

(52) U.S. Cl. CPC G06F 9/546; G06F 11/1004; G06F 13/20

(57) ABSTRACT

In an aspect of the present disclosure, an ad hoc protocol generation system is disclosed. The ad hoc protocol generation system may include a first processor configured to receive a function and a target device ID. The ad hoc protocol generation system may include a second processor in electronic communication with the first processor. The first processor may be programmed to transmit a synchronous signal to the second processor. The synchronous signal may include a payload containing an asynchronous protocol definition selected based on the target device ID. The payload may further contain a pass-through payload comprising the function. The second processor may be programmed to receive the synchronous signal and transmit an asynchronous signal to a target device. The asynchronous signal may be formatted according to the asynchronous protocol definition. The asynchronous signal may contain the pass-through payload.

### FIELD OF THE DISCLOSURE

The present disclosure relates to signal processing and protocol generation for serial digital communication signals.

### BACKGROUND OF THE DISCLOSURE

In a one-way digital communication stream including a primary processor, a secondary processor, and a downstream device, the primary processor transmits a primary signal to the secondary processor. This primary signal conveys a function to be performed by the downstream device. If, for example, the downstream device is a television, the function may increase the volume of the television. The secondary processor receives the primary signal, and then conveys the function to the downstream device via a secondary signal.

Typically, the downstream device will be configured to receive the secondary signal formatted by the secondary processor according a known protocol. The formatted secondary signal will contain a finite number of known payloads. In this configuration, both the secondary processor and the downstream device must be programmed to know the protocol and the corresponding expected outputs based on the payloads. Many unique protocols may exist, meaning the secondary processor must know and understand each unique protocol. Accordingly, the firmware of the secondary processor must be continually updated as the downstream device reconfigures to receive new payloads contained in signals formatted according to new protocols. Storing a wide array of payloads and protocols in the secondary microprocessor may consume excessive memory.

Accordingly, there is a critical need for a system which generates ad hoc protocols based on the payload of a signal with a known protocol.

### SUMMARY OF THE DISCLOSURE

In an aspect of the present disclosure, an ad hoc protocol generation system is disclosed. The ad hoc protocol generation system may include a first processor configured to receive a function and a target device ID. The ad hoc protocol generation system may include a second processor in electronic communication with the first processor. The first processor may be programmed to transmit a synchronous signal to the second processor. The synchronous signal may include a payload containing an asynchronous protocol definition selected based on the target device ID. The payload may further contain a pass-through payload comprising the function. The second processor may be programmed to receive the synchronous signal and transmit an asynchronous signal to a target device. The asynchronous signal may be formatted according to the asynchronous protocol definition. The asynchronous signal may contain the pass-through payload.

The payload of the synchronous signal may include a start flag. The payload of the synchronous signal may include a stop flag. The payload of the synchronous signal further may include the target device ID.

The asynchronous protocol definition may include a logic high definition. The asynchronous protocol definition may include a logic low definition.

The asynchronous protocol definition may include a definition of start bits. The asynchronous protocol definition may include a definition of stop bits. The asynchronous protocol definition may include a parity bit definition. The asynchronous protocol definition may include a cyclic redundancy checking definition. The asynchronous protocol definition may include a control codes definition. The asynchronous protocol definition may include an error checking scheme definition.

The asynchronous protocol definition may include a payload definition. The payload definition may correspond to the function.

The second processor may be configured to store the asynchronous signal. The asynchronous signal may be stored in a buffer of the second processor. The asynchronous signal may be stored in an external storage medium.

The payload of the synchronous signal may further include a repeat command, wherein the repeat command configures the second processor to transmit the stored asynchronous signal to the target device.

The payload of the synchronous signal may further include a command for the second processor to transmit a static high signal to the target device prior to transmitting the stored asynchronous signal. The payload of the synchronous signal may further include a command for the second processor to transmit a static high signal to the target device after transmitting the stored asynchronous signal.

The payload of the synchronous signal may further comprise a command for the second processor to transmit a static low signal to the target device prior to transmitting the stored asynchronous signal. The payload of the synchronous signal may further comprise a command for the second processor to transmit a static low signal to the target device after transmitting the stored asynchronous signal.

The first processor may be further programmed to transmit a second synchronous signal. The second synchronous signal may include a second payload containing the asynchronous protocol definition. The second payload may further contain a second pass-through payload comprising the function. The second processor may be further programmed to receive the second synchronous signal and transmit a second asynchronous signal to the target device. The second asynchronous signal may be formatted according to the asynchronous protocol definition. The second asynchronous signal may contain the second pass-through payload.

The second payload may further include a command for the second processor to transmit a static high signal to the target device prior to transmitting the second asynchronous signal. The second payload may further include a command for the second processor to transmit a static high signal to the target device after transmitting the second asynchronous signal.

The second payload may further include a command for the second processor to transmit a static low signal to the target device prior to transmitting the second asynchronous signal. The second payload signal may further include a command for the second processor to transmit a static low signal to the target device after transmitting the second asynchronous signal.

In another aspect of the present disclosure, an ad hoc protocol generation method is disclosed. The ad hoc protocol generation method may include receiving, at a processor, a synchronous signal having a known format and a payload containing an asynchronous protocol definition and a pass-through payload. The ad hoc protocol generation method may further include transmitting an asynchronous signal comprising the pass-through payload, wherein the asynchronous signal is formatted according to the asynchronous protocol definition.

### DESCRIPTION OF THE DRAWINGS

For a fuller understanding of the nature and objects of the disclosure, reference should be made to the following detailed description taken in conjunction with the accompanying drawings, in which:

FIG. 1 is a chart depicting an embodiment of the present disclosure;

FIG. 2 is a chart depicting a method according to another embodiment of the present disclosure; and

FIG. 3 is a diagram showing a system according to an exemplary embodiment of the present disclosure.

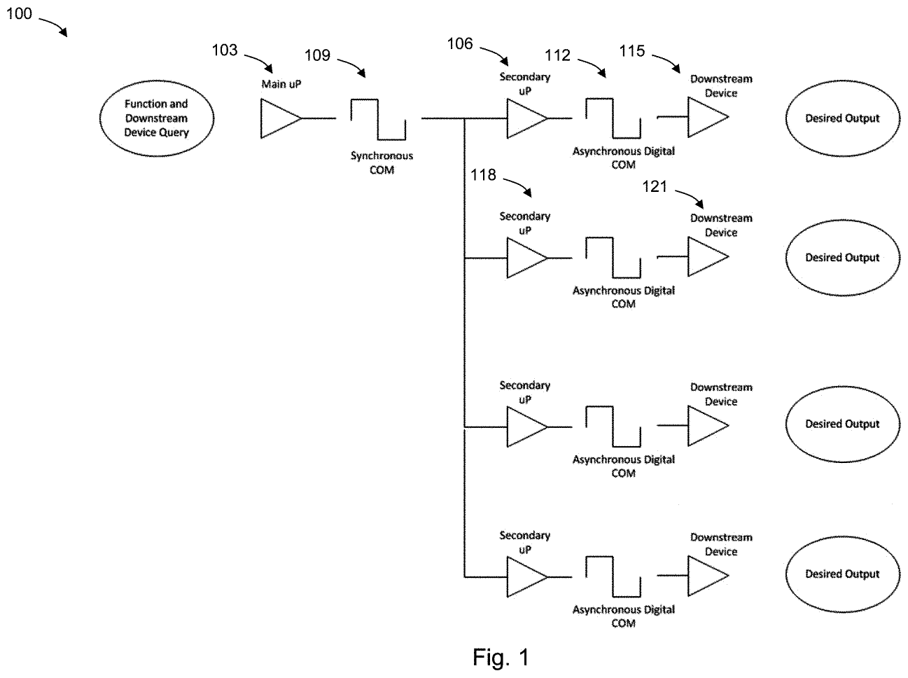

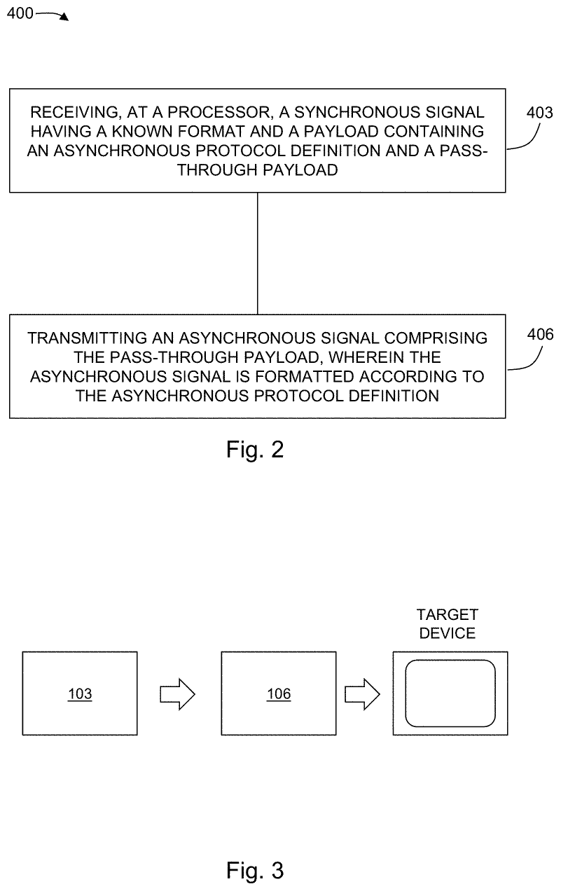

### DETAILED DESCRIPTION OF THE DISCLOSURE

In an aspect of the present disclosure, an ad hoc protocol generation system 100 is disclosed. The ad hoc protocol generation system 100 may include a first processor 103 configured to receive a function (i.e., a function request) and a target device identification (ID). The target device ID may be an identifier (e.g., a number, code, etc.) that uniquely identifies a target device—a device with which the system will ultimately communicate. For example, the target device may be a television, a set-top box, an entertainment system, an interactive infotainment system, etc. Using the non-limiting case of a television as a target device for illustrative purposes, it may be desired to cause the television to increase or decrease the volume, to increment or decrement the channel, to power on or power off, etc. Each of these actions may be considered a function. The first processor 103 of the ad hoc protocol generation system 100 may be configured to receive a function (e.g., power on) and a target device ID (e.g., television ID) on which to perform the function. In some embodiments, the first processor may be installed in a patient interaction device (“PID”) such as, for example, a pillow speaker.

The ad hoc protocol generation system 100 may include a second processor 106 in electronic communication with the first processor 103. The first processor 103 may be programmed to transmit a synchronous signal 109 to the second processor 106. The synchronous signal 109 may include a payload containing an asynchronous protocol definition selected based on the target device ID. The payload may further contain a pass-through payload including the function. The second processor 106 may be programmed to receive the synchronous signal 109 and transmit an asynchronous signal 112 to a target device 115, wherein the asynchronous signal 112 is formatted according to the asynchronous protocol definition and contains the pass-through payload. The second processor 106 may be installed in a patient hub. As the second processor 106 formats the asynchronous signal solely based upon the asynchronous protocol definition of the payload of the received synchronous signal 109, only the first processor 103 is required to dedicate resources to store protocols and payloads for different target devices (televisions, entertainment systems, etc.). Accordingly, if the target devices require new protocols or payloads, only the first processor 103 must be updated, as the second processor 106 is configured receive the synchronous signal from the first processor 103.

The synchronous signal 109 will typically support a higher data transfer rate than the asynchronous signal 112. The synchronous signal 109 may be formatted according to an existing protocol, such as Universal Serial Bus (USB) or I²C.

The ad hoc protocol generation system 100 may further include one or more additional processors 118 in electronic communication with the first processor 103. Each additional processor 118 is further connected to a corresponding additional target device 121.

The payload of the synchronous signal may include a start flag. The start flag may authorize the first processor 103 to transmit the synchronous signal 109 to the second processor 106. The payload of the synchronous signal may include a stop flag. The stop flag may trigger the first processor 103 to stop transmission of the synchronous signal 109 to the second processor 106. Additionally, the stop flag may authorize the second processor 106 to transmit the asynchronous signal 112 to the target device 115. The payload of the synchronous signal 109 further may include the target device ID.

The asynchronous protocol definition may include a logic high definition. The logic high definition may define the dwell time of a signal at a supply voltage level to designate a logic high. The asynchronous protocol definition may include a logic low definition. The logic low definition may define the dwell time of a signal at a ground level to designate a logic low.

The asynchronous protocol definition may include a definition of start bits. The asynchronous protocol definition may include a definition of stop bits. The asynchronous protocol definition may include a parity bit definition. The asynchronous protocol definition may include a cyclic redundancy checking (CRC) definition. The asynchronous protocol definition may include a control codes definition. The asynchronous protocol definition may include an error checking scheme definition. The asynchronous protocol definition may include a payload definition. The payload definition may correspond to the function.

The second processor 106 may be configured to store the asynchronous signal 112. The asynchronous signal 112 may be stored in a buffer of the second processor 106. The asynchronous signal 112 may be stored in an external storage medium. The payload of the synchronous signal may further include a repeat command, wherein the repeat command configures the second processor 106 to transmit the stored asynchronous signal 112 to the target device 115.

In an example of the present disclosure, the ad hoc protocol generation system 100 initiates a query for a function and a target device ID. The first processor 103 receives the function and target device ID, and configures a synchronous signal 109 with a payload according to the function and target device ID. The first processor 103 transmits the synchronous signal 109 to the second processor 106. The second processor 106 then configures an asynchronous signal 112 formatted according to the payload of synchronous signal. The second processor then transmits the asynchronous signal 112 to the target device 115, and the target device 115 executes the function.

In a further example of the present disclosure, the first processor 103 may configure the payload of the synchronous signal according to the function and target device ID as follows. The payload may begin with a start flag. The payload may then include a logic high definition for an asynchronous signal protocol corresponding to the target device ID. The payload may then include a logic low definition for the asynchronous signal protocol. The payload may then include a definition of start bits for the asynchronous protocol definition. The payload may then include a definition of stop bits for the asynchronous protocol definition. The payload may then include a parity bit definition for the asynchronous protocol definition. The payload may then include a CRC definition for the asynchronous protocol definition. The payload may then include an error checking scheme definition for the asynchronous protocol definition. The payload may then include control codes definitions for the asynchronous protocol definition. The payload may then include a pass-through payload, i.e., the payload of the asynchronous signal to be transmitted by the second processor 106. The payload may then conclude with a stop flag. In this example, all of the required information to construct the asynchronous signal 112 could be arranged in a completely serial configuration in a single data packet. Alternatively, the required information could be sequentially transmitted to registers within the second processor 106 to be acted upon when the second processor 106 receives transmit authorization from the first processor 103.

The payload of the synchronous signal may further include a command for the second processor 106 to transmit a static high signal to the target device 115 prior to transmitting the stored asynchronous signal 112. The payload of the synchronous signal may further include a command for the second processor 106 to transmit a static high signal to the target device 115 after transmitting the stored asynchronous signal 112. The payload of the synchronous signal may further comprise a command for the second processor 106 to transmit a static low signal to the target device 115 prior to transmitting the stored asynchronous signal 112. The payload of the synchronous signal may further comprise a command for the second processor 106 to transmit a static low signal to the target device 115 after transmitting the stored asynchronous signal 112.

The first processor 103 may be further programmed to transmit a second synchronous signal. The second synchronous signal may include a second payload containing the asynchronous protocol definition. The second payload may further contain a second pass-through payload comprising the function. The second processor 106 may be further programmed to receive the second synchronous signal and transmit a second asynchronous signal to the target device. The second asynchronous signal may be formatted according to the asynchronous protocol definition. The second asynchronous signal may contain the second pass-through payload.

The second payload may further include a command for the second processor 106 to transmit a static high signal to the target device 115 prior to transmitting the second asynchronous signal. The second payload may further include a command for the second processor 106 to transmit a static high signal to the target device 115 after transmitting the second asynchronous signal.

The second payload may further include a command for the second processor 106 to transmit a static low signal to the target device 115 prior to transmitting the second asynchronous signal. The second payload signal may further include a command for the second processor 106 to transmit a static low signal to the target device 115 after transmitting the second asynchronous signal.

In another aspect of the present disclosure, an ad hoc protocol generation method 400 is disclosed. The ad hoc protocol generation method may include receiving 403, at a processor, a synchronous signal having a known format and a payload containing an asynchronous protocol definition and a pass-through payload. The ad hoc protocol generation method may further include transmitting 406 an asynchronous signal comprising the pass-through payload, wherein the asynchronous signal is formatted according to the asynchronous protocol definition.

As described above, the payload of the synchronous signal may comprise a start flag to begin the definition of the asynchronous protocol. The asynchronous protocol definition may include a logic high definition and/or a logic low definition. The asynchronous protocol definition may include a definition of start bits, a definition of stop bits, and/or a parity bit definition. The asynchronous protocol definition may include an error checking scheme definition, a cyclic redundancy checking definition, and/or a control codes definition.

The asynchronous protocol definition may include a payload definition, the payload definition corresponding to the function. The payload of the synchronous signal may comprise a stop flag to begin the definition of the asynchronous protocol. The payload of the synchronous signal may include an identification (ID) of the target device.

The processor may be configured to store the asynchronous signal. For example the asynchronous signal may be stored in a buffer of the processor. In other examples, the processor may store the asynchronous signal in a memory device, such as, for example, an external storage medium (e.g., RAM, flash, etc.)

In some embodiments, the payload of the synchronous signal further includes a repeat command. The repeat command may cause (i.e., instruct) the processor to transmit the stored asynchronous signal to the target device one or more times.

The payload of the synchronous signal may have a command instructing the processor to transmit a static high signal to the target device prior to transmitting the stored asynchronous signal. The payload of the synchronous signal may have a command instructing the processor to transmit a static high signal to the target device after transmitting the stored asynchronous signal. The payload of the synchronous signal may have a command instructing the second processor to transmit a static low signal to the target device prior to transmitting the stored asynchronous signal. The payload of the synchronous signal may have a command instructing the second processor to transmit a static low signal to the target device after transmitting the stored asynchronous signal.

In some embodiments, the second processor may receive a second synchronous signal and transmitting a second asynchronous signal to the target device. The second asynchronous signal may be formatted according to the asynchronous protocol definition and contains the second pass-through payload. The second payload may have a command for the processor to transmit a static high signal to the target device prior to transmitting the second asynchronous signal. The second payload may have a command for the processor to transmit a static high signal to the target device after transmitting the second asynchronous signal. The second payload may have a command for the processor to transmit a static low signal to the target device prior to transmitting the second asynchronous signal. The second payload signal may have a command for the processor to transmit a static low signal to the target device after transmitting the second asynchronous signal.

Although the present disclosure has been described with respect to one or more particular embodiments, it will be understood that other embodiments of the present disclosure may be made without departing from the spirit and scope of the present disclosure.

1. An ad hoc protocol generation system, comprising:
a first processor configured to receive a function and a target device ID;
a second processor in electronic communication with the first processor;
wherein the first processor is programmed to transmit a synchronous signal to the second processor, the synchronous signal comprising a payload containing an asynchronous protocol definition selected based on the target device ID, and the payload further containing a pass-through payload comprising the function; and
wherein the second processor is programmed to receive the synchronous signal and transmit an asynchronous signal to a target device, wherein the asynchronous signal is formatted according to the asynchronous protocol definition and contains the pass-through payload.

2. The ad hoc protocol generation system of claim 1, wherein the payload of the synchronous signal comprises a start flag to begin the definition of the asynchronous protocol.

3. The ad hoc protocol generation system of claim 1, wherein the asynchronous protocol definition includes one or more of a logic high definition, a logic low definition, a definition of start bits, a definition of stop bits, a parity bit definition, an error checking scheme definition, a cyclic redundancy checking definition, a control codes definition, and a payload definition, the payload definition corresponding to the function.

4.-11. (canceled)

12. The ad hoc protocol generation system of claim 1, wherein the payload of the synchronous signal comprises a stop flag to begin the definition of the asynchronous protocol and/or further comprises the target device ID.

13. (canceled)

14. The ad hoc protocol generation system of claim 1, wherein the second processor is configured to store the asynchronous signal.

15. (canceled)

16. (canceled)

17. The ad hoc protocol generation system of claim 14, wherein the payload of the synchronous signal further comprises a repeat command, wherein the repeat command configures the second processor to transmit the stored asynchronous signal to the target device.

18. The ad hoc protocol generation system of claim 17, wherein the payload of the synchronous signal further comprises a command for the second processor to transmit a static high signal or a static low signal to the target device prior to transmitting the stored asynchronous signal.

19. The ad hoc protocol generation system of claim 17, wherein the payload of the synchronous signal further comprises a command for the second processor to transmit a static high signal or a static low signal to the target device after transmitting the stored asynchronous signal.

20. (canceled)

21. (canceled)

22. The ad hoc protocol generation system of claim 1, wherein the first processor is further programmed to transmit a second synchronous signal, the second synchronous signal comprising a second payload containing the asynchronous protocol definition, and the second payload further containing a second pass-through payload comprising the function, and wherein the second processor is further programmed to receive the second synchronous signal and transmit a second asynchronous signal to the target device, wherein the second asynchronous signal is formatted according to the asynchronous protocol definition and contains the second pass-through payload.

23. The ad hoc protocol generation system of claim 22, wherein the second payload further comprises a command for the second processor to transmit a static high signal or a static low signal to the target device prior to transmitting the second asynchronous signal.

24. The ad hoc protocol generation system of claim 22, wherein the second payload further comprises a command for the second processor to transmit a static high signal or a static low signal to the target device after transmitting the second asynchronous signal.

25. (canceled)

26. (canceled)

27. An ad hoc protocol generation method, comprising:
receiving, at a processor, a synchronous signal having a known format and a payload containing an asynchronous protocol definition and a pass-through payload; and
transmitting an asynchronous signal comprising the pass-through payload, wherein the asynchronous signal is formatted according to the asynchronous protocol definition by way of the synchronous protocol.

28. The method of claim 27, wherein the payload of the synchronous signal comprises a start flag to begin the definition of the asynchronous protocol.

29. The method of claim 27, wherein the asynchronous protocol definition includes one or more of a logic high definition, a logic low definition, a definition of start bits, a definition of stop bits, a parity bit definition, an error checking scheme definition, a cyclic redundancy checking definition, a control codes definition, and a payload definition, the payload definition corresponding to the function.

30.-37. (canceled)

38. The method of claim 27, wherein the payload of the synchronous signal comprises a stop flag to begin the definition of the asynchronous protocol and/or further comprises the target device ID.

39. (canceled)

40. The method of claim 27, wherein the second processor is configured to store the asynchronous signal.

41. (canceled)

42. (canceled)

43. The method of claim 40, wherein the payload of the synchronous signal further comprises a repeat command, wherein the repeat command configures the second processor to transmit the stored asynchronous signal to the target device.

44. The method of claim 43, wherein the payload of the synchronous signal further comprises a command for the second processor to transmit a static high signal or a static low signal to the target device prior to transmitting the stored asynchronous signal.

45. The method of claim 43, wherein the payload of the synchronous signal further comprises a command for the second processor to transmit a static high signal or a static low signal to the target device after transmitting the stored asynchronous signal.

46. (canceled)

47. (canceled)

48. The method of claim 27, wherein the first processor is further programmed to transmit a second synchronous signal, the second synchronous signal comprising a second payload containing the asynchronous protocol definition, and the second payload further containing a second pass-through payload comprising the function, and wherein the second processor is further programmed to receive the second synchronous signal and transmit a second asynchronous signal to the target device, wherein the second asynchronous signal is formatted according to the asynchronous protocol definition and contains the second pass-through payload.

49. The method of claim 48, wherein the second payload further comprises a command for the second processor to transmit a static high signal or a static low signal to the target device prior to transmitting the second asynchronous signal.

50. The method of claim 49, wherein the second payload further comprises a command for the second processor to transmit a static high signal or a static low signal to the target device after transmitting the second asynchronous signal.

51. (canceled)

52. (canceled)
